(19) United States
(12) Patent Application Publication
(10) Pub. No.: US 2026/0235642 A1
(43) Pub. Date: Aug. 13, 2026

(54) ATOMIC FORCE MICROSCOPE USING A SINGLE LIGHT SOURCE TO DRIVE CANTILEVER VIBRATIONS AND SENSE CANTILEVER MOTIONS

(71) Applicant: MOLECULAR VISTA, INC., San Jose, CA (US)

(72) Inventor: Thomas R. Albrecht, San Jose, CA (US)

(21) Appl. No.: 19/154,351

(22) PCT Filed: Feb. 6, 2024
(86) PCT No.: PCT/US2024/014643

§ 371 Date: Aug. 6, 2025

Related U.S. Application Data
(60) Provisional application No. 63/443,634, filed on Feb. 6, 2023.

(51) Int. Cl. G01Q 20/02

(52) U.S. Cl. CPC G01Q 20/02

(57) ABSTRACT

An atomic force microscope (AFM) and method of operating the AFM uses a light source on a cantilever with a tip to cause cantilever vibrations and also to measure cantilever motions. A driving system is used to modulate the light source to cause the cantilever vibrations and also to enable the light source to measure the cantilever motions.

### CROSS REFERENCE TO RELATED APPLICATION

This application is entitled to the benefit of U.S. Provisional Patent Application Ser. No. 63/443,634, filed on Feb. 6, 2023, which is incorporated herein by reference.

### BACKGROUND OF THE INVENTION

In an atomic force microscope (AFM), a light source, such as a focused laser diode, is often used in conjunction with an optical position sensing detector in an optical lever configuration to sense cantilever motions in an optical lever arrangement. In many AFM operating modes, such as noncontact or intermittent contact topographic mode, it is necessary to vibrate the cantilever, usually at one or more resonant frequencies of the cantilever. The most common approach is to use a piezoelectric transducer coupled to the cantilever mounting chip to drive cantilever vibrations.

Since cantilevers are consumable items that need to be replaced often, and resonant frequencies vary from cantilever to cantilever, it is necessary to determine the cantilever resonant frequencies to select a suitable frequency for driving cantilever vibrations. This is often done by applying a frequency-swept drive voltage to the piezoelectric transducer and using the optical lever to observe resonances as peaks in the vibration amplitude as a function of frequency. In addition to observing cantilever resonances, this approach often finds additional resonances of the surrounding structure, making it difficult to determine which peaks are true cantilever resonances versus resonances of the surrounding structure.

One well-accepted solution to this problem is to avoid using a piezoelectric transducer to drive cantilever vibrations, and instead use a modulated laser beam focused on the cantilever beam to excite vibrations. Absorption of the modulated light results in modulated heating of the cantilever, which causes modulated bending of the cantilever to excite vibrations. This approach is used to excite just the cantilever and avoid exciting resonances in the surrounding structure. A disadvantage of this approach is that it requires two light sources, one light source for measuring cantilever motions and a second light source for exciting cantilever vibrations. The use of two light sources, which usually include two laser diodes and associated focusing optics, adds cost and complexity to the design of the AFM head.

### SUMMARY OF THE INVENTION

An atomic force microscope (AFM) and method of operating the AFM uses a light source on a cantilever with a tip to cause cantilever vibrations and also to measure cantilever motions. A driving system is used to modulate the light source to cause the cantilever vibrations and also to enable the light source to measure the cantilever motions.

An AFM in accordance with an embodiment of the invention comprises a cantilever with a tip to engage a sample of interest, a light source to emit light onto the cantilever, and a driving system operably configured to modulate the light source to cause cantilever vibrations and also to enable the light source to measure cantilever motions.

A method of operating an AFM in accordance with an embodiment of the invention comprises modulating a light source directed to a cantilever with a tip to cause cantilever vibrations and to measure cantilever motions due to engagement of the tip with a sample of interest, detecting light of the light source reflected from the cantilever to measure the cantilever motions, and using measured cantilever motions to acquire AFM data of the sample of interest.

An AFM in accordance with an embodiment of the invention comprises a cantilever with a tip to engage a sample of interest, a light source to emit light onto the cantilever, a driving system operably configured to operate the light source at constant intensity for first time periods followed by second time periods with a light intensity from the light source reduced, wherein the second time periods cause cantilever vibrations and the first time periods are used to measure cantilever motions, a photodetector positioned to detect the light reflected off the cantilever to measure the cantilever motions, and a processing device operably coupled to the photodetector to receive measured cantilever motions to acquire AFM data of the sample of interest.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 shows an atomic force microscope (AFM) in accordance with an embodiment of the invention.

FIG. 2 is a pulse timing diagram for signals used the AFM depicted in FIG. 1 in accordance with an embodiment of the invention.

FIG. 3 is a flow chart of operating the AFM depicted in FIG. 1 in accordance with embodiments of the invention.

FIG. 4 is a process flow diagram of a method of operating an AFM in accordance with an embodiment of the invention.

Throughout the description, similar reference numbers may be used to identify similar elements.

### DETAILED DESCRIPTION

An atomic force microscope (AFM) in accordance with embodiments of the invention uses a single modulated laser diode focused onto a cantilever, which drives cantilever vibrations at a resonant frequency of the cantilever by using low-duty-cycle modulation of the laser beam at a subharmonic of the cantilever resonance. In its simplest embodiment, this laser runs at constant intensity for N−1 cycles (a first time period) of cantilever vibrations, and is then switched off or reduced in intensity for part of a single cycle (a second time period), before being turned on again at constant intensity to start the next sequence with this sequence repeating every N cycles. This results in a driving force on the cantilever with a frequency of F_{R}/N, where F_{R} is the resonant frequency of the cantilever.

Sensing of cantilever motions is accomplished in the usual way via a photosensor or photodetector in an optical lever configuration during the N−1 cycles for which the laser is running at constant intensity. A blanking function prevents sensing of motions during the individual cycle in which the laser is turned off or reduced in intensity. This is accomplished, for example, by using a lock-in detector or amplifier in the usual way for sensing cantilever vibrations, but switching its input off for exactly one cycle surrounding the moment when the laser light is interrupted. Since driving the cantilever at a subharmonic of the resonant frequency is inherently less efficient than driving at the resonant frequency itself, the cantilever may be engineered to increase the driving efficiency by using a semi-reflective coating of a specific material to increase the absorption of light at the wavelength of the laser and to select the thickness of the coating to increase the mechanical excitation caused by absorption of light. The location along the cantilever beam where the light is focused can be chosen to provide a favorable compromise between good driving efficiency and good signal-to-noise ratio (SNR) in detecting cantilever motion. The amplitude of cantilever vibrations can be controlled by adjusting the duration of time for which the light source is switched off. As an example, varying between 0-50% of one cycle of F_{R} corresponds to a range of zero to maximum available amplitude for a given subharmonic factor N. In addition to, or instead of varying the time duration of reduced intensity, the amount of intensity reduction can be adjusted to control amplitude, for example, by lowering the power to the light source.

Alternatively, the intensity of the laser during the constant intensity period can be used to control vibration amplitude. More intense light results in larger vibrations. However, changing the intensity of the light also affects the sensitivity of the vibration measurement. A third way to change the vibration amplitude is to change the factor N, where larger N results in less vibration amplitude and smaller N results in greater amplitude. The factor N, however, also affects measurement SNR, with smaller N resulting in lower SNR. Therefore, changing the duty cycle of the interruption, or the amount of reduction of light intensity during the interruption may be preferred, since this leaves the deflection measurement undisturbed by the method used to control the amplitude.

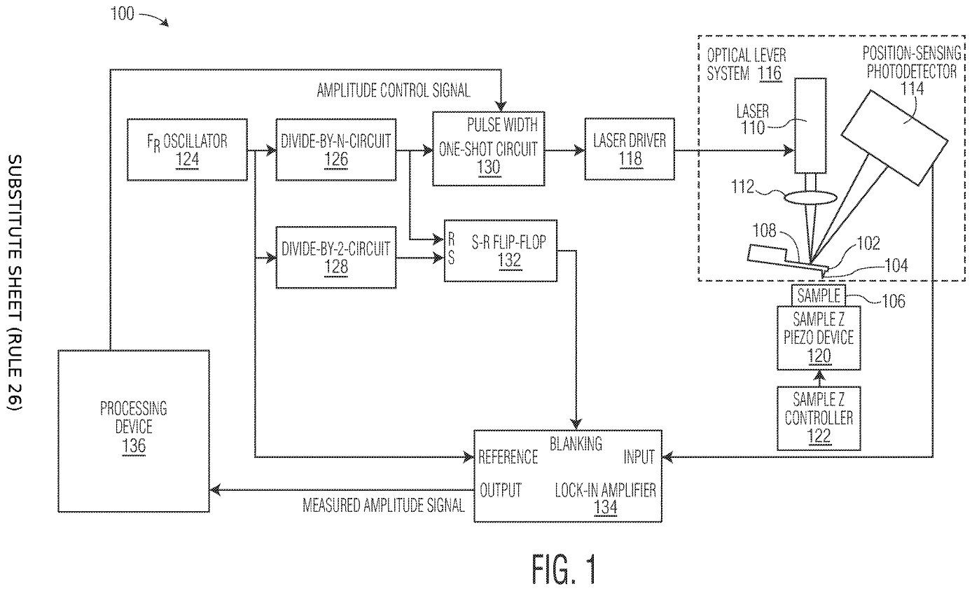

Referring to FIG. 1, an AFM 100 includes a force-sensing cantilever 102 with a sharp tip 104 facing toward a sample 106 of interest and an optical reflective surface 108 on the side away from the sample. Light from a light source 110, such as a laser, is focused on the reflective surface 108 of the cantilever 102 using a focusing lens 112, and is reflected off the reflective surface to a position-sensing photodetector 114. When the cantilever 102 is deflected, or bends, due to a force acting on the tip 104 of the cantilever when the tip is engaged with the sample 106, the angle of the reflective surface 108 on the cantilever changes, which changes the angle of the reflected beam and the position of the center of the beam on the position-sensing photodetector 114. This combination of the light source 110, the focusing lens 112, the reflective surface 108 on the short cantilever 102, and the position-sensing photodetector 114 some distance away comprises an “optical lever” system 116. Because the length of the cantilever 102 is very short compared to the length of the light path length between the cantilever and the photodetector 114, this optical “lever” multiplies the motion of the cantilever tip 104, converting a tiny motion of the tip into a much larger motion of the center of the beam on the photodetector 114. This type of “optical lever” is the most commonly used method of sensing cantilever motions in an AFM. Alternatively, an optical interferometer can be used to sense cantilever motion. In both cases, a light source, such as a laser, is used.

The light source 110 is driven by a laser driver 118, which sets the intensity of the light source, and can modulate the intensity of the light source via an input signal. In the prior art, a system referred to as blueDrive™ by Oxford Instruments Asylum Research modulates the intensity of the light source at a resonant frequency of the cantilever. The time-varying intensity of the modulated light results in time-varying thermal expansion of material within the cantilever. To the extent that this expansion is not uniform throughout the cantilever, it results in time-varying bending of the cantilever, which excites vibrations of the cantilever at the resonant frequency. Specifically, if the light results in expansion that is not uniform through the thickness of the cantilever beam, periodic bending of the cantilever causes it to vibrate. This nonuniformity in expansion can result simply from a larger absorption of light by the side of the cantilever facing the light source compared to the side of the cantilever away from the light source, or the nonuniformity can be enhanced by choosing a reflective coating or another layer within the construction of the cantilever to have a larger or smaller absorption of light than the rest of the material comprising the cantilever beam.

Since the method described herein may result in relatively inefficient driving of cantilever vibrations compared to the prior art blueDrive system due to driving at a subharmonic frequency with low duty cycle, an embodiment of the invention uses a silicon cantilever beam coated by a metallic reflective layer for the cantilever 102, with the metallic reflective layer chosen to have a higher absorption and a lower reflection of light than a metal chosen solely to maximize reflection at the wavelength of light used, which is typically red or infrared light in the range 600-1000 nm wavelength from a laser diode. In a particular embodiment, this metallic reflective layer is chosen from among the materials chromium, rhodium, platinum, platinum-iridium, nickel, and/or molybdenum, all of which have lower reflectivity and higher absorption than aluminum, silver, or gold, which are commonly used on cantilevers to maximize reflectivity. High reflectivity materials, however, or even no reflective coating at all may be used if sufficient vibration amplitude can be achieved with the system parameters available, and there is sufficient reflectivity for the optical lever detection system to work as desired. Virtually all metallic reflective materials have a higher coefficient of thermal expansion (CTE) than silicon, which has a value of approximately 5×10⁻⁶/Celsius or 5E−6/C. For example, nickel has a CTE of 13E−6/C and platinum has a value of 9E−6/C. While this value is lower than the highest reflectivity materials like aluminum (Al) (CTE=24E−6/C) and gold (Au) (CTE=14E−6/C), their higher absorption more than makes up for the reduced CTE. Furthermore, the higher modulus of materials like platinum, platinum-iridium, nickel, and chromium compared to higher reflectivity materials like aluminum and gold make them more efficient at driving cantilever vibrations with embodiments of this invention.

The choice of where to focus the light on the cantilever beam 102 also affects the performance of embodiments of this invention. With the blueDrive system, since two separate light sources are used, each may be focused to a different point along the cantilever beam to maximize the effectiveness of the driving light source (e.g., focused near the fixed base of the cantilever for the lowest frequency vibrational mode of the cantilever, or near a point of large curvature for the particular vibrational mode of the cantilever being driven) and the motion sensing light source (e.g., focused near the free end of the cantilever for the lowest frequency mode, or near a point of large slope for the particular mode is being driven). Since embodiments of this invention have a single light source, i.e., the light source 110, a compromise may be necessary, with the light focused at a point between a point of high curvature and a point of high slope. When driving the cantilever to vibrate at resonant frequency higher than its lowest resonant frequency, the more complex vibrational mode shape should be considered in selecting the right compromise position of the light for simultaneous driving and sensing. Examples of complex vibrational mode shapes that can be used are described in Raman et al., “Cantilever dynamics in atomic force microscopy,” Nano Today, February-April 2008, which is incorporated herein by reference.

The sample 106 of interest may be placed on a sample z piezo device 120, which can move the sample in the z-direction, i.e., towards or away from the tip 104. The sample z piezo device 120 is controlled by a sample z controller 122, which may move the sample z piezo device as needed.

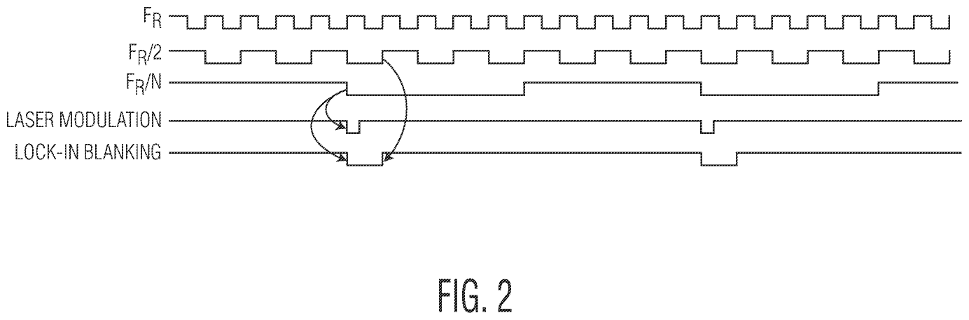

In order to drive the cantilever 102 to cause cantilever vibrations and sense cantilever motions using the single light source 110, the AFM 100 includes an oscillator 124, a divide-by-N circuit 126, a divide-by-2 circuit 128, a one-shot circuit 130, a set-reset (S-R) flip-flop 132 and a lock-in amplifier 134. The operations of these components are described below with reference to FIG. 2, which is a pulse timing diagram for signals used in the AFM 100 in accordance with an embodiment of the invention.

Referring to FIGS. 1 and 2, the oscillator 124, which may be a synthesized frequency generator, produces a square wave at the resonant frequency F_{R} of the cantilever 102. This signal serves as the reference signal for the lock-in amplifier 134, which is used to measure the vibration amplitude using the signal from the photodetector 114. To generate a subharmonic frequency, the divide-by-N circuit 126, which may be a self-resetting counter circuit, generates a subharmonic frequency F_{S}, which equals F_{R} divided by N. This signal in turn triggers the one-shot circuit 130 with an adjustable pulse width. The pulse width of the one-shot circuit 130 is controlled by an amplitude control signal applied to the pulse width input of the one-shot circuit. The output of the one-shot circuit 130 in turn turns off or reduces the intensity of the light source 110 during the pulse. Maximum excitation of cantilever vibrations for a fixed value N occurs when the light source 110 is turned off for a duration of ½ cycle of F_{R} with each pulse from the one-shot circuit 130. The amplitude of vibrations may be reduced either by choosing an intensity higher than zero during the pulse, or by using a pulse shorter than ½ cycle. The light source 110, which may include a laser diode with an electronic driving circuit, may have some effective time delay in turning off at the beginning of the pulse and in turning back on and stabilizing after the end of the pulse. Thus, the pulse length and timing may be adjusted to compensate for these effects. Coarse adjustment of vibration amplitude may be made by changing the value of N for the divide-by-N circuit 126; higher N results in lower amplitude.

As described above, the oscillator 124, the divide-by-N circuit 126, the one-shot circuit 130 and the laser driver 118 operate to cause cantilever vibrations, as well as sense cantilever motions due to the engagement of the tip 104 of the cantilever 102 with the sample 106. Thus, these components can be viewed as forming a laser driving system or subharmonic driving system to drive the light source 110 to cause the cantilever vibrations and to measure the cantilever motions.

Since the same light source is used for sensing cantilever motions, care must be taken to ensure that the sensing system can operate properly with the light source modulated. Normally in an AFM, the light source has constant intensity. A solution to allow modulation of the light source 110 is to effectively disable the input of the lock-in amplifier 134 (i.e., set the input signal level to zero) while the intensity of the light source is reduced or turned off. As used herein, reduction of light source intensity (i.e., intensity of light from the light source) may include the light source being turned off. Ideally, the input of the lock-in amplifier 134 (“lock-in input”) is disabled for a time interval with a duration of one full cycle of F_{R}, with the time interval including all of the time where the light source 110 is reduced in intensity or turned off. Since a full cycle of F_{R} is more than the modulation pulse time (typically no more than ½ cycle of F_{R}), the additional time may be used to disable the lock-in input during the time after the pulse where the laser diode has not yet fully stabilized at constant intensity. Disabling the lock-in input is accomplished by a blanking input on the lock-in amplifier 134 (or in a separate circuit before the input of the lock-in amplifier) that effectively forces the input signal to zero during a blanking signal pulse. Blanking pulses with a duration of one full cycle of F_{R} may be generated by the S-R flip-flop 132 for which the output goes to a logic low signal at the moment the R input is triggered, and goes to a logic high signal when the S input is triggered. With the R input of the S-R flip-flop 132 connected to the divide-by-N circuit 126 and the S input of the S-R flip-flop 132 connected to the divide-by-2 circuit 128, the pulse timing diagram of FIG. 2 applies, and the blanking signal (i.e., the output of the S-R flip-flop 132) goes low for one cycle or approximately (+/−10%) one cycle at the beginning of each modulation pulse of the laser 110. The lock-in amplifier 134 is configured so that its input is disabled when the blanking signal is a logic low signal.

Disabling the lock-in input via the blanking pulse for a single cycle every N cycles reduces the detected signal amplitude at the output of the lock-in amplifier 134 by a factor of (N−1)/N. For a relatively large value of N, such as 10, this reduction in output is only 10%, which has only a minor effect on detection signal-to-noise ratio. If N is reduced to 2, which is the smallest value for which embodiments of this invention normally can work, the detected amplitude is reduced by 50% and the reduction in signal-to-noise ratio is more substantial. The output filter of the lock-in amplifier 134 needs to be adjusted to filter out all frequencies higher than F_{R}/N. Therefore if N is large, detection bandwidth may be significantly reduced. However, in most practical AFM setups, F_{R} is 10-1000 times higher than the detection bandwidth needed to operate the AFM properly, so a value of N=10 has little or no impact on detection bandwidth that may limit the speed of operation of the AFM 100.

The output of the lock-in amplifier 134, which is the measured amplitude signal, is transmitted to a processing device 136, where the measured amplitude signal can be used to acquire AFM data of the sample 106, such as image data or measurements, using conventional methodologies. The processing device 136 can be any device with one or more processors and/or controllers to process the measured amplitude signal, as well as control various components of the AFM 100. One particular control signal provided by the processing device 136 is the amplitude control signal to the one-shot circuit 130 to adjust the output pulse width.

It should be understood by those skilled in the art that many variations of the system shown in FIG. 1 may be used to accomplish subharmonic driving of cantilever vibrations and sensing of cantilever motions with a single light source.

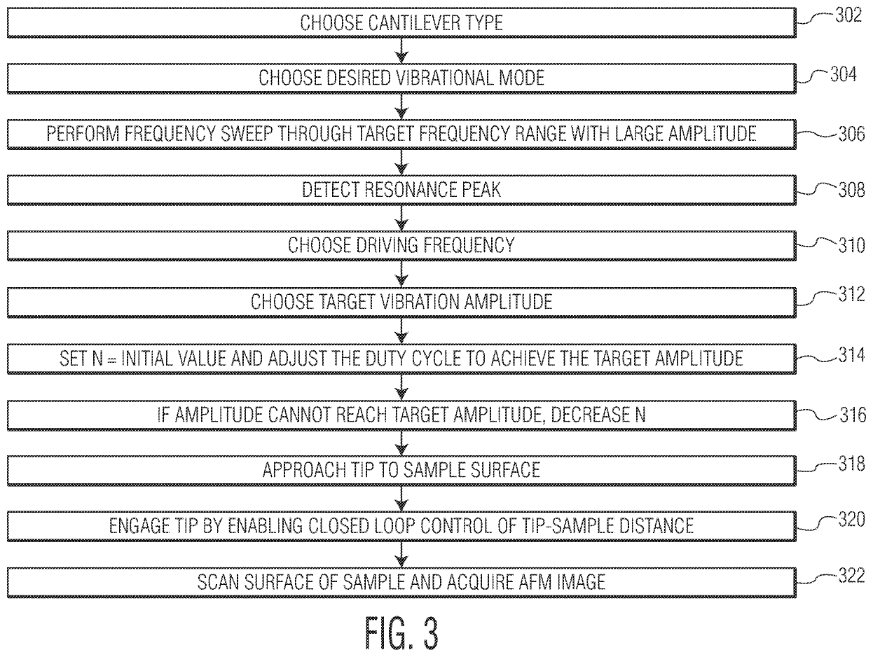

FIG. 3 shows a flow chart of operating the AFM 100 in accordance with embodiments of this invention. At step 302, a type of cantilever to be used in the AFM 100 is chosen. Cantilevers are typically commercially made, and each type has a known range of frequencies for the vibrational modes of interest.

Next, at step 304, a particular vibrational mode to be used in the AFM 100 is chosen. For Photo-induced Force Microscopy (PiFM), the second vibrational mode is often chosen. Once the mode has been selected, the range of frequencies possible for that mode are known. The range of frequencies may be provided by the manufacturer or measured in a prior experiment.

Next, at step 306, a frequency sweep is performed through a target frequency range while using the subharmonic driving system of the AFM 100 to drive the cantilever 102 at a relatively large amplitude, so that low-noise detection of cantilever motion is easy. A low value of N, such as N=2, and 50% duty cycle may be used for this step to enable driving a large amplitude. While sweeping, amplitude vs. frequency data is recorded.

After sweeping, the resonance peak frequency of the vibrational mode is determined by observing which frequency had the highest amplitude, at step 308. The width of the resonance peak and other characteristics of the resonance peak may also be determined for the purpose of selecting an appropriate driving frequency.

Next, at step 310, using the known resonant frequency and peak shape, a suitable driving frequency is selected, as is conventional for the AFM mode of operation being used. For the commonly used amplitude sensing mode, the driving frequency is typically slightly above the resonant peak frequency, partway down the decreasing slope of amplitude in the frequency region just above the resonance peak.

Next, at step 312, the target vibration amplitude is chosen when the tip 104 is far from the sample surface. Many factors contribute to the choice of amplitude. For PiFM, the target amplitude is often in the range of 0.2-2 nm root mean square (RMS).

Next, at step 314, the vibration amplitude is adjusted to match the target amplitude by the methods described previously. For example, the duty cycle of the time the laser 110 is turned off or reduced in amplitude may be adjusted to reach the target amplitude. An initial value of N, such as N=8, may be used to provide good SNR for amplitude measurement during normal AFM operation.

Next, at step 316, if the target amplitude cannot be reached with maximum duty cycle (time off=50% of one period at F_{R}), choose a lower value of N iteratively until the target amplitude can be reached, down to a minimum value of N=2. Since reducing N reduces the SNR of amplitude detection, it is optimal to use the largest value of N that will enable reaching the target amplitude, up to a point. Beyond N=8, improvements in SNR are small, so it may not be necessary to use values larger than 8. At this point, the AFM is ready for normal operation.

Next, at step 318, using conventional methods, the tip is brought close to the sample surface (the “approach”).

After approaching, at step 320, the tip 104 is engaged with the sample surface, which means that closed-loop control of the tip-sample using changes in cantilever vibration amplitude as a measure of changes in tip-sample spacing. Tip-sample spacing can be regulated by different methods, depending on the AFM operating mode.

After engaging, at step 322, an AFM image may be acquired by scanning the tip 104 position relative to the sample surface, or performing other AFM measurements of interest, such as the acquisition of a PiFM image, or taking a PiF spectrum at a particular point on the sample surface.

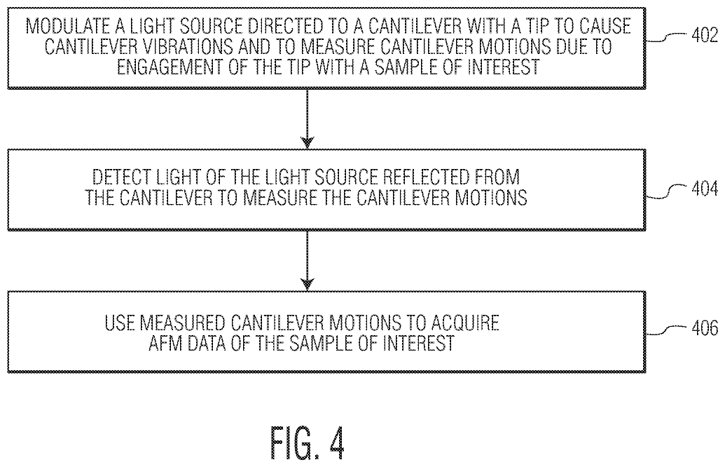

Turning now to FIG. 4, a flow diagram of a method of operating an AFM, such as the AFM 100, in accordance with an embodiment of the invention is shown. At block 402, a light source directed to a cantilever with a tip is modulated to cause cantilever vibrations and to measure cantilever motions due to engagement of the tip with a sample of interest. At block 404, light of the light source reflected from the cantilever is detected to measure the cantilever motions. At block 406, measured cantilever motions are used to acquire an AFM data of the sample of interest.

It will be readily understood that the components of the embodiments as generally described herein and illustrated in the appended figures could be arranged and designed in a wide variety of different configurations. Thus, the detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. An atomic force microscope (AFM) comprising:
a cantilever with a tip to engage a sample of interest;
a light source to emit light onto the cantilever; and
a driving system operably configured to modulate the light source to cause cantilever vibrations and also to enable the light source to measure cantilever motions.

2. The AFM of claim 1, wherein the driving system is configured to modulate the light source at a subharmonic frequency of a cantilever resonant frequency to cause the cantilever vibrations.

3. The AFM of claim 2, wherein the light source is part of an optical lever system using a position-sensing photodetector for detecting the cantilever motions.

4. The AFM of claim 2, wherein the driving system is configured to operate the light source at constant intensity for multiple cycles of the cantilever resonant frequency periodically followed by a partial cycle with a light intensity from the light source reduced or turned off to modulate the light source at the subharmonic frequency of the cantilever resonant frequency.

5. The AFM of claim 4, wherein the driving system is configured to control an amplitude of the cantilever vibrations by varying a time length of the partial cycle when the light intensity is reduced or turned off.

6. The AFM of claim 4, wherein the driving system is configured to control an amplitude of the cantilever vibrations by varying an amount of reduction in light intensity during the partial cycle when the light intensity is reduced.

7. The AFM of claim 4, wherein the driving system is configured to control an amplitude of cantilever vibrations by changing a value of the constant intensity outside of the partial cycle when the light intensity is reduced or turned off.

8. The AFM of claim 2, wherein the driving system is configured to enable a coarse adjustment of an amplitude of cantilever vibrations by selecting a specific subharmonic frequency at which the light source is modulated.

9. The AFM of claim 3, wherein the driving system is configured to measure an amplitude of the cantilever motions using a lock-in amplifier acting on a signal produced by the position-sensing photodetector, the lock-in amplifier having a reference signal at a cantilever vibration frequency.

10. The AFM of claim 9, wherein the driving system is configured to operate the light source at constant intensity for multiple cycles of the cantilever resonant frequency periodically followed by a partial cycle with a light intensity from the light source reduced or turned off to modulate the light source at the subharmonic frequency of the cantilever resonant frequency.

11. The AFM of claim 10, wherein an input signal to the lock-in amplifier is set to zero by a blanking signal during a time interval that includes the partial cycle with the light intensity reduced or turned off.

12. The AFM of claim 11, wherein the time interval during which the input signal is set to zero has a duration of approximately one cycle of the cantilever resonant frequency.

13. The AFM of claim 1, wherein the cantilever has a reflective coating that includes chromium, rhodium, platinum, platinum-iridium, nickel, or molybdenum.

14. A method of operating an atomic force microscope (AFM), the method comprising:
modulating a light source directed to a cantilever with a tip to cause cantilever vibrations and to measure cantilever motions due to engagement of the tip with a sample of interest;
detecting light of the light source reflected from the cantilever to measure the cantilever motions; and
using measured cantilever motions to acquire AFM data of the sample of interest.

15. The method of claim 14, wherein modulating the light source includes modulating the light source at a subharmonic frequency of a cantilever resonant frequency to cause the cantilever vibrations.

16. The method of claim 15, wherein modulating the light source at the subharmonic frequency of the cantilever resonant frequency includes operating the light source at constant intensity for multiple cycles of the cantilever resonant frequency periodically followed by a partial cycle with a light intensity from the light source reduced or turned off.

17. The method of claim 16, further comprising controlling an amplitude of the cantilever vibrations by varying a time length of the partial cycle when the light intensity is reduced or turned off, by varying an amount of reduction in light intensity during the partial cycle when the light intensity is reduced, or by changing a value of the constant intensity outside of the partial cycle when the light intensity is reduced or turned off.

18. The method of claim 14, further comprising measuring an amplitude of the cantilever motions using a lock-in amplifier acting on a signal produced by a position-sensing photodetector, the lock-in amplifier having a reference signal at a cantilever vibration frequency.

19. The method of claim 18, wherein modulating the light source at the subharmonic frequency of the cantilever resonant frequency includes operating the light source at constant intensity for multiple cycles of the cantilever resonant frequency periodically followed by a partial cycle with a light intensity from the light source reduced or turned off, and wherein an input signal to the lock-in amplifier is set to zero by a blanking signal during a time interval that includes the partial cycle with the light intensity reduced or turned off.

20. An atomic force microscope (AFM) comprising:
a cantilever with a tip to engage a sample of interest;
a light source to emit light onto the cantilever;
a driving system operably configured to operate the light source at constant intensity for first time periods followed by second time periods with a light intensity from the light source reduced, wherein the second time periods cause cantilever vibrations and the first time periods are used to measure cantilever motions;
a photodetector positioned to detect the light reflected off the cantilever to measure the cantilever motions; and
a processing device operably coupled to the photodetector to receive measured cantilever motions to acquire AFM data of the sample of interest.
